(19) United States
(12) Patent Application Publication
(10) Pub. No.: US 2012/0120234 A1
(43) Pub. Date: May 17, 2012

(54) PLATFORM SCREEN DOOR

(75) Inventors: Colin Fullalove, Melksham Wiltshire (GB); Colin Gradwell, Melksham Wiltshire (GB); Ross Bradley, Melksham Wiltshire (GB); Nick Bradley, Melksham Wiltshire (GB)

(73) Assignee: Knorr Bremse Rail Systems (UK)Limited, Melksham Witshire (GB)

(21) Appl. No.: 12/514,754

(22) PCT Filed: Sep. 18, 2007
(86) PCT No.: PCT/GB2007/003520

§ 371 Date: Jun. 2, 2011

(30) Foreign Application Priority Data
Sep. 18, 2006 (GB) 0618316.4

(51) Int. Cl. E05F 15/06; H04N 7/18

(52) U.S. Cl. 348/143; 49/70; 348/E07.085

(57) ABSTRACT

A platform screen door system, comprising a fixed panel, a door leaf slidably disposed adjacent to the fixed panel, a drive means adapted to slidingly move the door leaf from a door open position to a door closed position; and a microprocessor adapted to control the movement of the drive means and, thereby, control the movement of the door leaf The system also includes a media panel, disposed on the fixed panel, wherein the media panel is adapted to display information.

### CROSS-REFERENCE TO RELATED APPLICATION(S)

This U.S. Non-Provisional Patent Application relies for priority on PCT Patent Application No. PCT/GB2007/003520, filed on Sep. 18, 2007, and on Great Britain Patent Application No. 0618316.4, filed on Sep. 18, 2006, the contents of both of which are incorporated herein by reference.

### FIELD OF INVENTION

The invention relates to a platform screen door system.

### DESCRIPTION OF RELATED ART

The conventional railway station consisting of a raised platform adjacent to the track is essentially the same design as has been used since the beginning of the railway industry in the nineteenth century and is an effective solution to the problem of maximising passenger boarding speed.

However, the basic platform arrangement suffers from several well known problems, such as passengers falling under trains either deliberately or unintentionally and also litter from passengers falling onto the track. Although incidents of people falling under trains are not common, they result in significant disruption to the network and are traumatic incidents for everyone present. The problem of litter on the track has also increased in recent years and can represent a serious health and safety risk on underground or sub-surface systems where the litter will remain in tunnels until it is cleared up.

Platform screen door systems or automated platform gates are well known in the railway industry as one approach of dealing with these problems. Due to the problem of lining up doors on the platform and the train, these systems are usually only installed on lines where the rolling stock is standardised, which in practice is on metro or underground systems, although some dedicated high speed systems are also provided with screens. Presently installed full height door systems usually comprise toughened glass panels as passengers find that solid walls tend to be claustrophobic. Some door systems use so called half height doors, which are also known as gates, and these tend to be made of metal or composite materials as passengers can see over the barriers.

Known platform screen door systems simply provide a safety barrier between the platform edge and the train and tracks. Due to the high costs of installing the systems, they are generally only installed on new lines and only rarely are retro-fitted to the large number of existing platforms. The present invention seeks to provide an improved screen door system that will be more economic to install.

### SUMMARY OF THE INVENTION

According to the invention there is provided a platform screen door system comprising a fixed panel and a door leaf, drive means adapted to slidingly move the door leaf from a door open position to a door closed position, and a microprocessor adapted to control the movement of the door, wherein the fixed panel is provided with a media panel, which media panel is adapted to display information, wherein the information displayed is controllable by a further microprocessor.

Advantageous embodiments of the invention are discussed in the description that follows.

### BRIEF DESCRIPTION OF THE DRAWINGS

An exemplary embodiment of the invention will now be described in greater detail with reference to the drawing in which:

FIG. 1 shows a platform screen door system; and

FIG. 2 shows a cross section of the door system.

### DETAILED DESCRIPTION OF EMBODIMENT(S) OF THE INVENTION

While the discussion that follows concerns the embodiment(s) illustrated in the drawings appended to this specification, the invention is not intended to be limited solely to the embodiments shown and/or described. To the contrary, the invention is intended to encompass equivalents and variations, as would be understood by those skilled in the art.

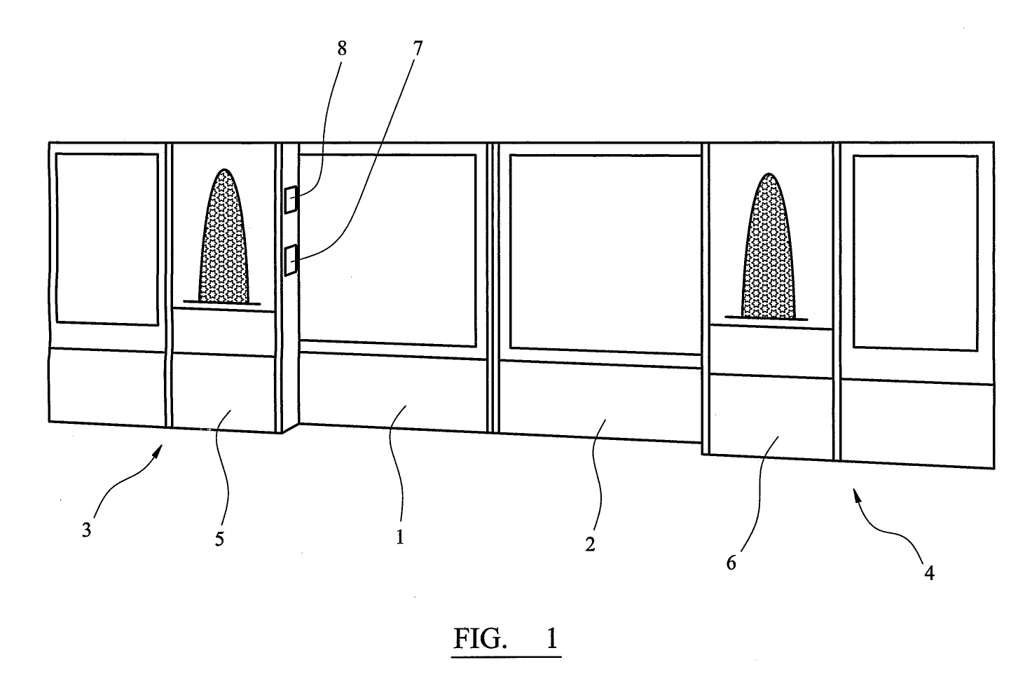

FIG. 1 shows a platform screen door system with the doors in the closed position comprising first 1 and second sliding door leaves 2, which door leaves are adapted to slide in opposite directions to one another. When in use, each sliding door leaf 1, 2 will slide behind a respective fixed panel 3, 4, which is adjacent to the sliding door in the closed position. The door system is also provided with an audio system 7 so that passengers can be warned when the door is about to be closed or if specific messages need to be relayed to passengers.

The fixed panels 3, 4 each have a lower portion having a metallic surface and are each provided with a media panel 5, 6 on an upper part of the panel. Due to space restrictions on the platform, the media panel is ideally a flat screen such as an LCD panel. As many platforms are quite narrow, 2-3 m being common, to aid visibility, the panel should ideally also be high definition so that it can be viewed clearly both close up and from further away at acute viewing angles.

The operation of the media panels 5, 6 is controlled in conjunction with the platform screen door control system. When the train is in the correct position, a door enable signal is transmitted to the doors. This can be achieved either by the signaling system or by a local sensor based system. Once the door enable signal is received by the local door control unit, the door control unit will provide a visual alert on the media screen 5, 6 that the door is opening and provide train related information such as destination of the train. When the door close signal is sent from the train, the door control unit will provide a visual alert that the doors are about to close, thereby enhancing the known aural alert. The media panels are generally controlled by a separate microprocessor or server, which is adapted to feed the media content to the media panels. However, the door control unit can transmit a signal to the media panel adjacent to the door controlled by the media panel so that this can display information from the door system such as if a door is out of order.

Each media panel 5, 6 along the platform is individually addressable by the control system, e.g. by providing it with its own IP address. To facilitate this, the platform screen door control system is provided with a multi-channel communication system, which on a typical installation can be four channels. The operation of the media panel is also linked to the individual door control units.

The individual addressability of the screens has a number of advantages over known screen door and platform systems. In particular it would enable passenger loading information to be displayed in advance so that passengers can direct themselves or be directed to carriages which are emptier, which will speed up loading times at the station. Reduced loading times speeds up the journey times and increases utilisation of resources so that a higher frequency service can be run with existing rolling stock. It would also be possible to transmit other information such as where to board a train so that the passenger was at the point on the train closest to the exit at their desired station or at popular stations, which again would speed up de-training. As the doors are individually addressable each door could display a different message, e.g. if a door were out of order.

The media panels 5, 6 have a number of additional uses. In normal operation of the train system, the media panels can be used to display advertisements. As door systems often obscure advertisements placed on the wall of the tunnel remote from the platform on underground systems and also as the advertisements need no longer be static and as several advertisement could be shown between trains, the media panel should be able to enhance advertising revenue. For metro systems that have female only carriages, the individual addressability of the media panels would enable different advertisements to be directed at the female only doors.

As the media panels 5, 6 are linked to the local door control units, it is also possible to use the panel as a maintenance screen when the door system is serviced. At present, engineers typically have to bring laptop computers with them but by using the media panel as a maintenance screen, it is possible to reduce or avoid the use of laptops, which will speed up and reduce maintenance costs. The maintenance screen is able to display data logged by the platform screen door system and its associated controllers.

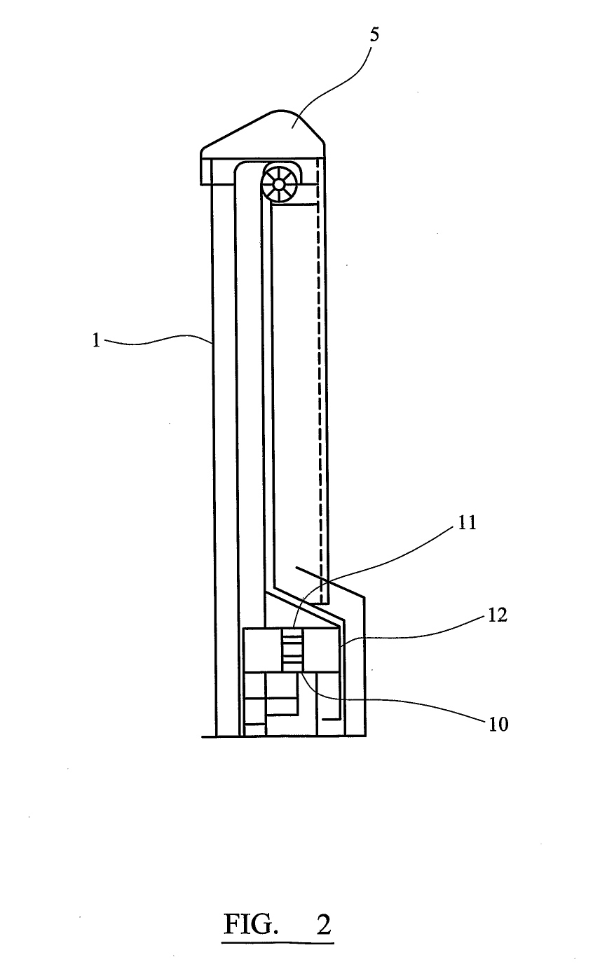

FIG. 2 shows a cross-section of the door system shown in FIG. 1 having a door leaf 1 and a fixed panel 3. The platform screen door system is provided with a microprocessor control system 10, which is adapted to control the opening and closing of the doors. The door system is provided with a guide 12, motor 11 and control electronics to drive the door leaf between the open and closed positions. Typically the motor and control electronics can be housed in the base of the fixed panel 3 in the conventional manner. Each door leaf 1 is provided with a door control unit, which is adapted to control the operation of the motor to open and close the respective door leaf 1 or pair of door leaves 1, 2 under instruction from the microprocessor 10. The control unit is also adapted to detect unexpected loads on the doors, which may indicate an obstruction, and to brake the closing of the door in the event of an obstruction being detected.

In a second aspect of the invention, the fixed panels 3, 4 are provided with a CCTV camera 8 in the area adjacent to the free edge of the fixed panel with the door in the open position. This arrangement is advantageous over the conventional arrangements of CCTV cameras on the ceilings of platforms as the cameras will look directly at people boarding trains at about head height. Conventional systems tend to be placed above head height and look along the platform. It is therefore fairly easy to avoid the camera being able to picture the face of a passenger who is wearing a hood. The arrangement of the camera in this aspect will be able to photograph passengers' faces as they enter the train unless the passenger wears a mask. Using wide angle cameras or cameras that are adapted to pan during the doors closed position enables the performance of existing CCTV systems to be replicated as well as providing enhanced coverage of passengers' faces, thereby leading to improved security and crime reduction.

Although the system has been described as having one media panel adjacent to each door leaf, it would of course be possible to have one media panel per opening in the door system.

The invention is suitable for use in both full height door systems and half height systems, in which the doors are also called gates.

1. A platform screen door system, comprising:
a fixed panel;
a door leaf slidably disposed adjacent to the fixed panel;
drive means adapted to slidingly move the door leaf from a door open position to a door closed position; and
a microprocessor adapted to control the movement of the drive means and, thereby, control the movement of the door leaf; and
a media panel, disposed on the fixed panel, wherein the media panel is adapted to display information.

2. A platform screen door system according to claim 1, wherein the information displayed is controllable by the microprocessor.

3. A platform screen door system according to claim 2, comprising a plurality of media panels, wherein each panel is individually addressable by the microprocessor so that a first panel can display different information from a second panel.

4. A platform screen door system according to claim 3, wherein each media panel is assigned an individual IP address.

5. A platform screen door system according to claim 1, wherein the media panel comprises a high definition screen.

6. A platform screen door system according to claim 1, wherein the media panel comprises a maintenance panel adapted to display operational data logged and/or system information stored by the platform screen door system.

7. A platform screen door system according to claim 1, further comprising:
a CCTV camera.
